(19) United States
(12) Patent Application Publication
(10) Pub. No.: US 2024/0334095 A1
(43) Pub. Date: Oct. 3, 2024

(54) COEXISTENCE OF MULTIPLE OPTICAL SERVICES WITHIN PASSIVE OPTICAL NETWORK AND PASSIVE OPTICAL MODULE FOR THE SAME

(71) Applicant: CommScope Technologies LLC, Hickory, NC (US)

(72) Inventors: Kristofer BOLSTER, Jordan, MN (US); Jill Anne MALECHA, New Prague, MN (US); Jan Jozef Julia Maria ERREYGERS, Tielt-Winge (BE)

(73) Assignee: CommScope Technologies LLC, Hickory, NC (US)

(21) Appl. No.: 18/575,632

(22) PCT Filed: Jun. 30, 2022
(86) PCT No.: PCT/US2022/035819

§ 371 Date: Dec. 29, 2023

Related U.S. Application Data
(60) Provisional application No. 63/218,025, filed on Jul. 2, 2021.
(60) Provisional application No. 63/304,314, filed on Jan. 28, 2022.

(51) Int. Cl. H04Q 11/00; H04J 14/02

(52) U.S. Cl. CPC H04Q 11/0067; H04J 14/0282; H04Q 2011/0064

(57) ABSTRACT

A passive optical module delivers multiple passive optical services. The passive optical services are received from a central office on a single fiber optic cable. The passive optical module provides high channel isolation between services, thereby ensuring high-quality service, while allowing multiple services to be distributed using the same fiber optic cable. A passive optical network filter arrangement is optically connected to a common optical connection and provides a passive optical network service connection, the passive optical network filter arrangement has a reflect port. A splitter can be provided in a common housing as the passive optical network filter arrangement.

### CROSS-REFERENCE TO RELATED APPLICATIONS

This application is being filed on Jun. 30, 2022 as a PCT International Patent Application and claims the benefit of U.S. Patent Application Ser. No. 63/218,025, filed on Jul. 2, 2021 and claims the benefit of U.S. Patent Application Ser. No. 63/304,314, filed on Jan. 28, 2022, the disclosures of which are incorporated herein by reference in their entireties.

### BACKGROUND

Various methods of routing optical signals from any upstream location within a network to downstream subscribers are known. For example, subscriber locations, such as residential locations or commercial locations, are often routed one or more types of passive optical services, such as gigabit passive optical network (GPON) and 10-Gigabit symmetrical passive optical network (XGS-PON) services.

As network providers expand types of high bandwidth services to residential and business customers, more and different types of service are required to be distributed from a central office to remote locations. For example, point to point signals may be routed via optical fibers, such as backend portions of a cellular telephone network. These services typically operate at different wavelengths as compared to the subscriber services described above, but at relatively closely-spaced frequency bands. It is highly desirable to avoid the cost and effort of having to route additional optical fibers between a central office and outside plant equipment, which in turn distribute services to subscribers. However, existing equipment may not adequately provide the ability to combine services onto existing optical distribution fibers without experiencing significant loss at outside-plant equipment due to the filters, splitters, wavelength division multiplexers, and other optical equipment required to separate those services for delivery from an outside-plant location to individual subscribers.

Accordingly, a service provider wishes to combine point-to-point services and subscriber services on a common optical network, it can be difficult to achieve efficient routing with adequate isolation between types of services.

### SUMMARY

In general, the present application is directed to passive optical modules that may be used to deliver multiple passive optical services from a central office on a single fiber optic cable. The fiber optic cable may be a cable that was distributed to an outside plant location, for example to deliver passive optical network services. In aspects described herein, both passive optical network services and point-to-point services may be delivered on the same optical fiber(s), thereby reducing the need for laying of additional optical fibers as new services are provided from a central office to remote locations.

In a first aspect, a passive optical module includes a common optical connection optically coupled to a single optical fiber received from a central office, the single optical fiber carrying a plurality of optical services thereon, the plurality of optical services including a passive optical network service and a point-to-point optical service having a plurality of groups of optical channels. The module includes a passive optical network filter optically connected to the common optical connection and providing passive optical network service connection, the passive optical network filter having a reflect port. The module further includes a plurality of point-to-point optical filters optically connected in a cascaded arrangement. Each point-to-point optical filter receives optical signals from a reflect port of one other filter within the passive optical module and includes a point to-point optical service connection for one of the plurality of groups of channels, the one other filter being one of (1) the passive optical network filter or (2) another of the point-to-point optical filters.

In a second aspect, a method of delivering multiple optical services from a central office is described. The method includes, delivering from a central office to an outside plant location, one or more passive optical network services on a common optical fiber with a plurality of point-to-point services, the passive optical network services and the point-to-point services being delivered using different ranges of wavelengths. The method further includes, at the outside plant location, receiving the common optical fiber at a passive optical module. The method also includes delivering a passive optical network service at a passive optical network service connection of the passive optical module, the passive optical network service connection being optically connected to the passive optical network service connection via a passive optical network filter arrangement having a reflect port. The method includes delivering a plurality of point-to-point optical services from the passive optical module, wherein each of the plurality of point-to-point optical services is provided at the output of a point-to-point optical filter of a plurality of point-to-point optical filters optically connected in a cascaded arrangement.

In a further aspect, a coexistence module may be located at a central office, and may be used to combine multiple passive optical network services onto a single fiber routed between the central office and an outside plant location. The outside plant location may, in some embodiments, be implemented as a fiber-optic splice enclosure, in which a fiber optic splice module may be located. The fiber optic splice enclosure may be a weatherproof enclosure located in a particular neighborhood or vicinity of a plurality of subscribers, such as customers and/or businesses, wireless provider endpoints (e.g., cellular access point antennas).

At the outside plant location, a further coexistence module may be positioned within that fiber optic splice closure. The coexistence module may receive the single optical fiber routed from the central office, and separate the various passive optical network services for delivery to subscribers. In some instances, the coexistence module may be implemented as a cassette that may be positioned within a fiber-optic splice enclosure, or may be a sealed splice tray positioned within such a fiber-optic splice enclosure. Other configurations may be used as well.

In some embodiments, a fiber distribution hub may also be used, for example to house a splitter which receives passive optical network services and distributes those services to the subscribers. In alternative embodiments, the splitter may be included within the outside plant location, for example within the fiber optic splice enclosure, where the coexistence module is also located.

In some embodiments, the coexistence module and the splitter may be implemented as a cassette that may be positioned within the fiber-optic splice enclosure, or may be a sealed splice tray positioned within such a fiber-optic splice enclosure. The cassette may be mounted on a tray, or the sealed splice tray may be hingedly mounted in the closure along with other trays, such as trays containing splices.

### BRIEF DESCRIPTION OF THE DRAWINGS

FIG. 1 illustrates a passive optical network in which aspects of the present disclosure may be implemented.

FIG. 2 is a schematic view of a first example coexistence module usable within a passive optical network, according to an embodiment of the present disclosure.

FIG. 3 is a schematic view of a second example coexistence module usable within a passive optical network, according to an embodiment of the present disclosure.

FIG. 4 is a schematic view of a third example coexistence module usable within a passive optical network, according to an embodiment of the present disclosure.

FIG. 5 is a schematic view of a fourth example coexistence module usable within a passive optical network, according to an embodiment of the present disclosure.

FIG. 6 is a schematic view of a fifth example coexistence module usable within a passive optical network, according to an embodiment of the present disclosure.

FIG. 7 is a schematic view of a sixth example coexistence module usable within a passive optical network, according to an embodiment of the present disclosure.

FIG. 8 is a schematic view of a seventh example coexistence module usable within a passive optical network, according to an embodiment of the present disclosure.

FIG. 9 is a schematic view of an eighth example coexistence module usable within a passive optical network, according to an embodiment of the present disclosure.

FIG. 10 is a schematic view of a ninth example coexistence module usable within a passive optical network, according to an embodiment of the present disclosure.

FIG. 11 is a schematic view of a tenth example coexistence module usable within a passive optical network, according to an embodiment of the present disclosure.

FIG. 12 is a schematic view of an eleventh example coexistence module usable within a passive optical network, according to an embodiment of the present disclosure.

FIG. 13 is a perspective view of an example fiber-optic splice enclosure.

FIG. 14 shows the fiber-optic splicing closure of FIG. 13 without the dome cover.

FIG. 15 shows an example tray from the enclosure of FIGS. 13 and 14 including fiber optic splices.

FIG. 16 shows a sealed splice tray from the enclosure of FIGS. 13 and 14.

FIG. 17 shows a further view of the sealed splice tray of FIG. 16.

FIG. 18 shows a similar tray to the trays of FIGS. 15-17, and including two cassettes carried by the tray.

FIG. 19 shows one of the cassettes of FIG. 18.

FIG. 20 illustrates a passive optical network in which aspects of the present disclosure may be implemented.

### DETAILED DESCRIPTION

As briefly described above, embodiments of the present invention are directed to use of a specific type of module within a passive optical network to deliver multiple types of optical services from a central office to an outside point location, which is typically proximate to a number of subscribers (e.g., residential customers and business subscribers). In accordance with the examples provided below, a number of different coexistence modules may be used within a passive optical network to combine multiple optical services onto a common distribution fiber, and separate those multiple optical services for delivery to subscribers from an outside plant location. By carefully managing the isolation between different optical services, multiple services may be delivered along a common optical fiber, thereby reducing the requirement of laying additional optical fibers between a central office and an outside plant location.

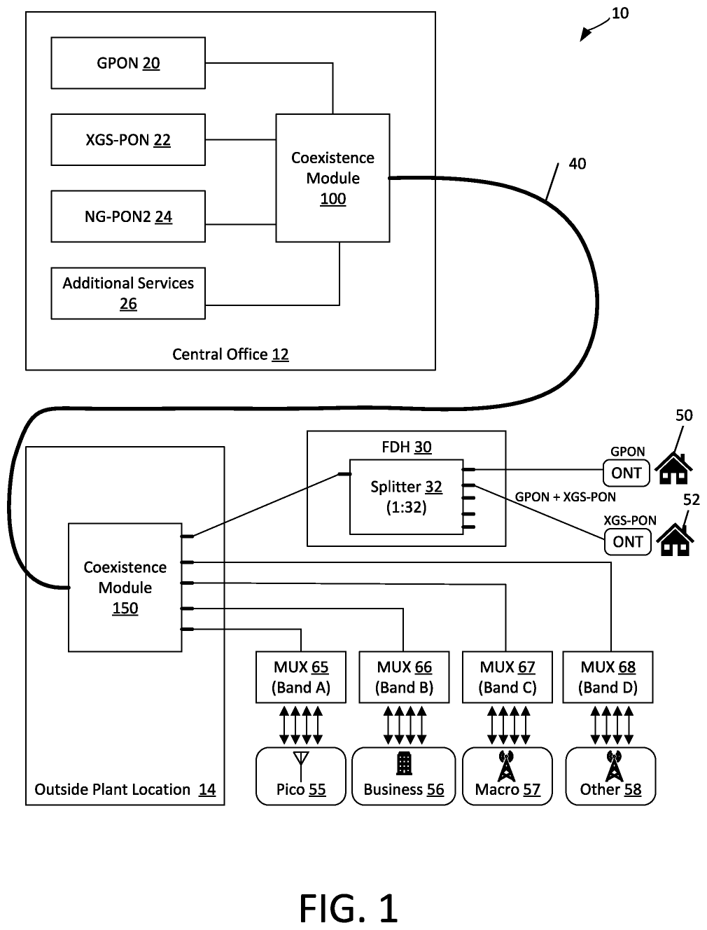

Referring first to FIG. 1, a schematic illustration of an example passive optical network 10 is provided, in which aspects of the present disclosure may be implemented. The passive optical network 10 provides optical services routed from a central office 12 to subscriber locations via an outside plant location 14.

At the central office 12, a service provider may wish to provide a plurality of different passive optical services. In the example shown, the passive optical services include gigabit passive optical network (GPON) 20, 10-Gigabit symmetrical passive optical network (XGS-PON) 22, and Next-Generation Passive Optical Network 2 (NG-PON2) services 24. Additionally, other services 26 may be provided. For example, dedicated wavelength services used for business entities or back end data transmission for wireless carriers may be provided. Furthermore, 25 Gb or 50 Gb passive optical network services, or point-to-point services may also be provided, either alone or in combination with the above described services.

In the example shown, a coexistence module 100 may be located at the central office, and may be used to combine multiple passive optical network services onto a single fiber 40 routed between the central office 12 and outside plant location 14. The outside plant location 14 may, in some embodiments, be implemented as a fiber-optic splice enclosure, in which a fiber optic splice module may be located. The fiber optic splice enclosure may be a weatherproof enclosure located in a particular neighborhood or vicinity of a plurality of subscribers, such as customers and/or businesses, wireless provider endpoints (e.g., cellular access point antennas), etc.

At the outside plant location 14 a further coexistence module 150 may be positioned within that fiber optic splice closure. The coexistence module 150 may receive the single optical fiber 40 routed from the central office 12, and separate the various passive optical network services for delivery to subscribers. In some instances, the coexistence module 150 may be implemented as a cassette that may be positioned within a fiber-optic splice enclosure, or may be a sealed splice tray positioned within such a fiber-optic splice enclosure. Other configurations may be used as well.

The subscriber locations may be any of a variety of types of subscribers. In the example shown, a first subscriber 50 may receive gigabit passive optical network (GPON) service, via an optical network terminal (ONT). A second subscriber 52 may receive 10-Gigabit symmetrical passive optical network service (XGS-PON), via a similar ONT. Other subscribers may receive, for example, 25 Gbit or 50 Gbit passive optical network services, as described below in conjunction with certain coexistence modules. In the example shown, a fiber distribution hub (FDH) 30 may also be used, for example to house a splitter 32 which receives passive optical network services and distributes those services to the subscribers 50, 52. In alternative embodiments, the splitter 32 may be included within the outside plant location 14, for example within a fiber optic splice enclosure.

In addition to subscriber locations 50, 52, a number of other services may be distributed from the coexistence module 150. For example, piconets 55, business services 56, large-scale wireless services 57 such as cellular network services, or other wireless services 58 may be routed through the coexistence module 150 of the outside plant location 14. Such services may include a plurality of optical wavelength bands, or channels, and associated multiplexers 65, 66, 67, 68 may be used to distribute specific channels to particular equipment.

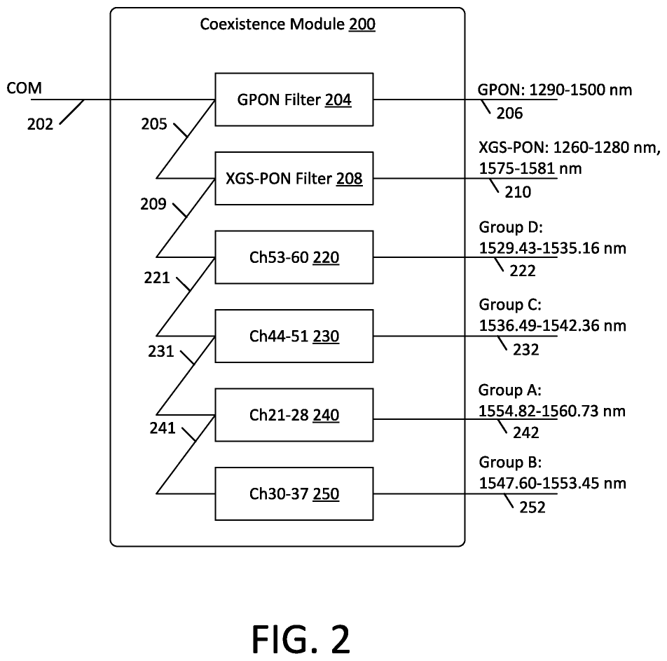

Referring now to FIGS. 2-11, various configurations of coexistence modules are described which may be used as coexistence module 100, or coexistence module 150, in accordance with the present disclosure. The selection of the specific coexistence module depends, in part, on the location of the coexistence module (e.g. at central office 12 or outside plant location 14) as well as the specific services to be distributed from the central office 12 to subscribers. In general, the coexistence modules 100, 150 allow for combining of the various passive optical network services into a single fiber. In particular, the optical characteristics of the optical filters used in various embodiments described herein (in particular, the isolation and directivity characteristics of filters optically spliced together in various cascaded arrangements), improved channel isolation can be achieved with a minimization of insertion loss.

FIG. 2 is a schematic view of a first example coexistence module 200 usable within a passive optical network, according to an embodiment of the present disclosure. As noted above, the coexistence module 200 may be used as one of the coexistence modules at central office 12 or outside plant location 14, e.g. as one of coexistence modules 100, 150.

In the example shown, the coexistence module 200 includes a common fiber connection 202, which may be optically connected to a fiber optic service, such as a service via optical fiber 40. In such a case, the coexistence module 200 may be implemented within a fiber-optic splice enclosure, at a location proximate a group of subscribers. The common fiber connection 202 optically connected to a GPON filter 204. The GPON filter 204 is generally a passband filter that allows passage of optical wavelengths in a range of 1290-1500 nm, corresponding to a general range of wavelengths within which GPON services are provided. In some embodiments the GPON filter 204 is selected to have an insertion loss of less than or equal to 1.1 dB from the common fiber connection 202 to a GPON connection 206.

In the example shown, the GPON filter 204 routes all non-passed optical signals received at the common fiber connection 202 to an XGS-PON filter 208, e.g., via a reflect port 205 of the GPON filter 204. The XGS-PON filter 208 acts as a further band-pass filter, allowing passage of wavelengths in the range of 1260-1280 nm and 1575-1581 nm, and reflecting non-passed wavelengths at its reflect port 209. Furthermore, in some embodiments the XGS-PON filter 208 is selected to provide a loss of than or equal to 1.1 dB from the common fiber connection 202 to an XGS-PON connection 210.

Still further, in the example shown, a further set of cascaded filters are provided that connect separate channels for use in delivering business or wireless services via the same common fiber connection 202. In the example shown, a filter 220 receives the optical signals from the reflect port 209 of the XGS-PON filter 208 and connects, at a group connection 222, a range of optical channels which are adjacent to one another in a wavelength range of 1529.43-1535.16 nm, with an insertion loss of less than or equal to 1.5 dB. Similarly, a second filter 230 receives the optical signals from the reflect port 221 of the first filter 220 and provides, at a group connection 232, a range of optical channels which are adjacent to one another in a wavelength range of 1536.49-1542.36 nm, with an insertion loss of less than or equal to 1.9 dB. A third filter 240 receives the optical signals from the reflect port 231 of the second filter 230 and provides, at a group connection 242, a range of optical channels which are adjacent to one another in a wavelength range of 1554.82-1560.73 nm, with an insertion loss of less than or equal to 2.3 dB. A fourth filter 250 receives the optical signals from the reflect port 241 of the third filter 240 and provides, at a group connection 252, a range of optical channels which are adjacent to one another in a wavelength range of 1547.60-1553.45 nm, with an insertion loss of less than or equal to 2.0 dB.

Accordingly, using each of the PON filters 204, 208, and cascaded filters 220, 230, 240, 250, relatively narrowly-spaced channels of optical signals may be combined on a common fiber 40 at a connection 202, and distributed at remote locations with relatively low insertion loss and high channel isolation, to ensure high quality service without requiring laying of additional fibers between a central office and remote locations.

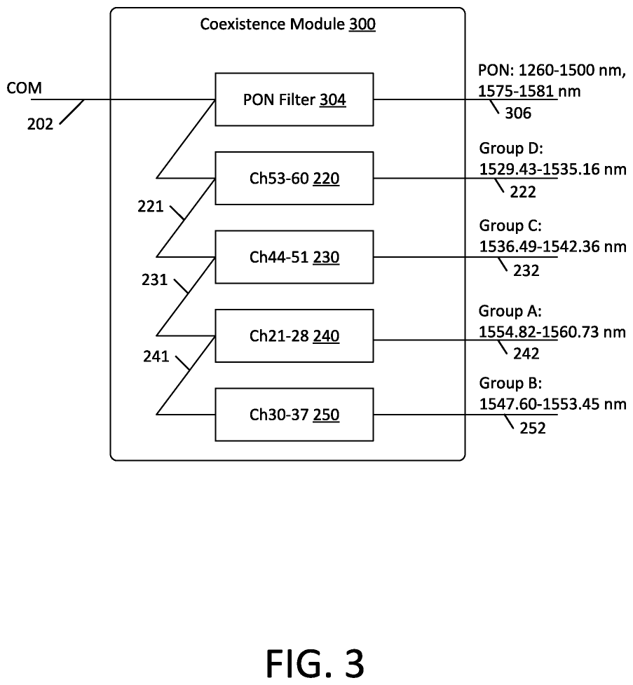

FIG. 3 is a schematic view of a second example coexistence module 300 usable within a passive optical network, according to an embodiment of the present disclosure. Generally, the module 300 corresponds to the module 200, except that it excludes the XGS-PON filter 208 and dedicated XGS-PON connection 210. Instead, in this embodiment, the wavelengths providing XGS-PON services will pass through a PON filter 304, to a connection 306. Accordingly, the coexistence module 300 would be used in the specific arrangement seen in FIG. 1, in which both GPON and XGS-PON services are delivered from the same coexistence module 150 to a splitter 32, with upstream filtering between the GPON and XGS-PON services (e.g., at OLTs). In some examples, the insertion loss between a connection 306 from a PON filter 304 can be equal to or less than 0.9 dB. Other insertion losses would be as described above in conjunction with the coexistence module 200.

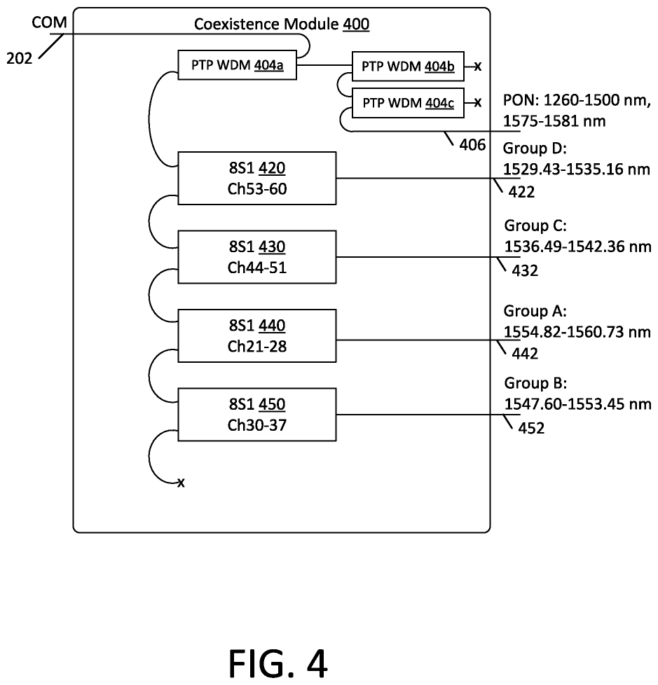

FIG. 4 is a schematic view of a third example coexistence module 400 usable within a passive optical network, according to an embodiment of the present disclosure. The coexistence module 400 represents a further possible configuration using wavelength division multiplexers to achieve a similar effect to that of the coexistence module 300 of FIG. 3. In this example, rather than PON filter 304, a series of PTP wavelength division multiplexers are used to select particular wavelength bands. That is, a connection from a series of interconnected PTP wavelength division multiplexers 404a-c may provide PON services at a connection 406 having wavelengths in the range of 1260-1500 nm (GPON and 1575-1581 nm (XGS-PON). A filtering arrangement in which eight channels of wavelength pairs within a set of adjacent wavelengths (e.g., using eight-skip-one (8S1) filters) may be used to provide the analogous channel connections described above in connection with FIGS. 2-3. Specifically, four groups of channels, noted as Groups A-D, are provided from filters 420, 430, 440, 450, at connections 422, 432, 442, and 452, respectively.

In this example embodiment, because the PON signals at connection 406 are routed from the connection 202 via the reflect port of WDM 404a onto the common port of WDM 404b, and then the reflect port of WDM 404b is spliced to the common port of WDM 404c, with PON signals at connection 406 being on a reflect port of WDM 404c, isolation of 45 dB or greater is possible, given the use of respective reflect ports and the associated channel isolation (e.g., about 15 dB per filter).

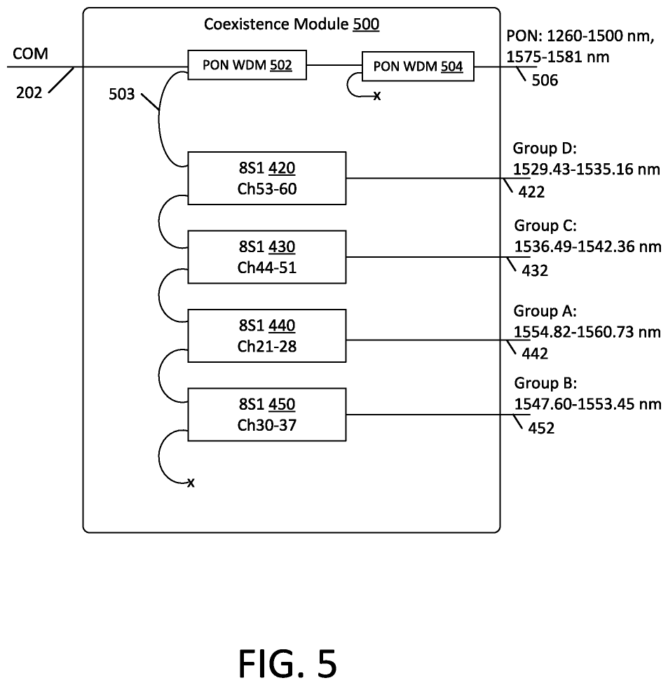

FIG. 5 is a schematic view of a fourth example coexistence module 500 usable within a passive optical network, according to an embodiment of the present disclosure. The coexistence module 500 has a similar function to that of coexistence modules 300, 400 of FIGS. 3-4, but in this instance, uses a pair of PON WDMs 502, 504 to connect between a common fiber connection 202 and PON connection 506. As compared to the configuration seen in FIG. 4, use of PON WDMs 502, 504 allows for selection of the two particular bands of wavelengths to be used for PON services (e.g., operating as a dual pass-band filter), with remaining wavelengths being passed to filters 420, 430, 440, 450, and subsequent connections 422, 432, 442, and 452, respectively, as noted above. In this example, the PON WDMs use a reflect port 503 of PON WDM 502 to pass group services to those filters 420, 430, 440, 450. The wavelengths delivered at connection 506 may be attenuated by 15 dB at the reflect port 503. Furthermore, each of filters 420, 430, 440, 450 provide a further 30 dB of isolation at subsequent connections 422, 432, 442, and 452. Accordingly, a 45+dB isolation of signals that are delivered to connection 506 may be achieved for the services from the common fiber connection 202 at connections 422, 432, 442, 452. Further, the signals received at connections 422, 432, 442, 452 may be attenuated by 50+dB at connection 506 due to directivity at the PON WDM 502 and isolation provided by PON WDM 504.

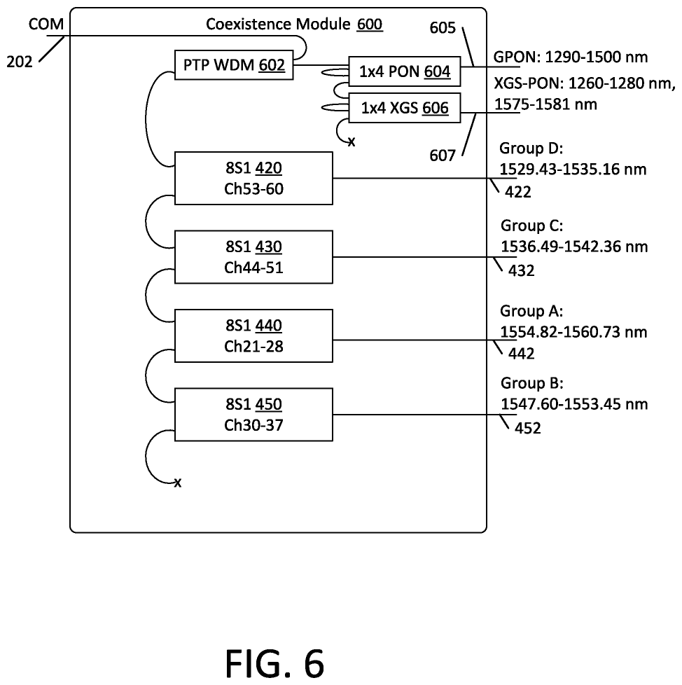

FIG. 6 is a schematic view of a still further possible coexistence module 600 usable within a passive optical network. The coexistence module 600 uses a PTP wavelength division multiplexer 602, which receives the common fiber connection 202. Wavelengths in the GPN and XGS-PON wavelength range as described above are passed to a 1×4 PON filter 604, which is spliced to a 1×4 XGS filter 606. These 1×4 filters generally represent dual filter arrangements that provide increased channel isolation (e.g., 30+dB at a reflect port). The PON filter 604 provides a GPON service connection 605, and the XGS filter 606 provides an XGS-PON service connection 607. The services passed through the PTP wavelength division multiplexer 602 are then passed to filters 420, 430, 440, 450, and subsequent connections 422, 432, 442, and 452, respectively, as noted above.

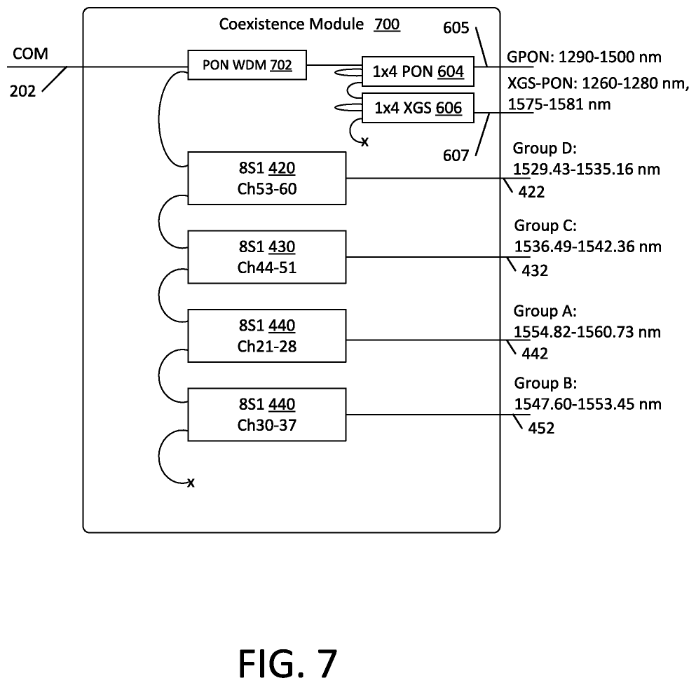

FIG. 7 illustrates a similar construction to that seen in FIG. 6, but shows a coexistence module 700 that uses a PON wavelength division multiplexer 702 in place of the PTP wavelength division multiplexer 602. Generally, in this context, the PON wavelength division multiplexer will pass PON wavelengths and reflect PTP wavelengths, while the PTP wavelength division multiplexer 602 passes PTP wavelengths (such as those on connections 422, 432, 442, 452) but reflects PON signals. Accordingly, different combinations and interconnections of such filters may be made to achieve different levels of channel isolation and/or loss, as desired for a particular application. Logical components of the coexistence module 700 are otherwise analogous to those described above in conjunction with FIG. 6.

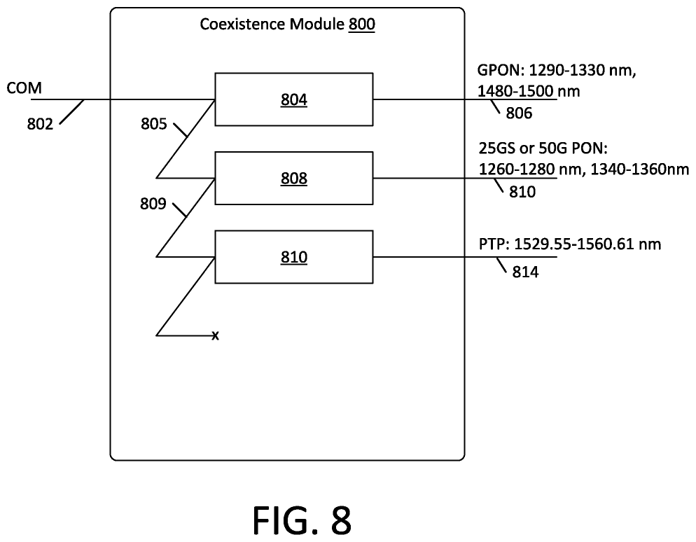

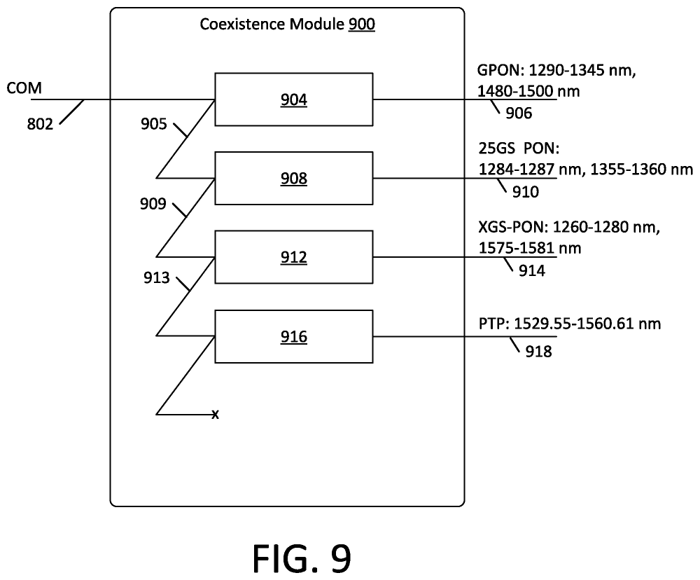

FIGS. 8 and 9 illustrate still further example coexistence modules which may be used, and which can provide output of multiple passive optical services. In these examples, the root channels used for point-to-point services (e.g. Groups A through D) are not separated within the coexistence module, but instead may be separated outside the coexistence module by one or more other filter or wavelength division multiplexer arrangements.

In the example shown in FIG. 8, a coexistence module 800 has a common fiber connection 802 received at a GPON filter 804, which passes wavelengths in the range of 1290 to 1330 nm as well as from 1480 to 1500 nm, at GPON output 806. The reflect port 805 of the GPON filter 804 reflects the remaining wavelength signals, which are routed to a filter 808 which passes wavelengths in the range of 1260 to 1280 nm and 1340 to 1360 nm. Such a wavelength range may be used for 25 Gb or 50 Gb PON services, at output 810. The reflect port 809 of the filter 808 is further routed to a point-to-point filter 812, which passes wavelengths at connection 814 in a range of 1529.55 to 1560.61 nm, corresponding to the overall wavelength range of Groups A through D, described above. As with previous embodiments, channel isolation between, e.g., the common fiber connection 802 and an output of signals at connection 814 includes 45 dB of channel isolation as compared to signal levels at the common fiber connection 802. Given the selection of components, for upstream signals from connections 814, 810, the directivity characteristics of the upstream filters from each connection will provide even greater isolation among channels.

As compared to FIG. 8, an example coexistence module 900 of FIG. 9 includes separate GPON and XGS-PON filters used to provide separate connections for those services, respectively. That is, the coexistence module 100 receives fiber 802 to a GPON filter 904, which outputs a GPON signal on output 906 having a wavelength range of 1290 to 1345 nm and 1480 to 1500 nm. The wavelength band of 1290 to 1345 nm allows for a future upgrade of the service on this port to the ITU-T 50G-PON service (with 1342 nm downstream wavelength and 1290-1310 nm upstream wavelength). The reflect port 905 of the GPON filter 904 may then be optically connected to a filter 908 which passes wavelengths in the range of 1284 to 1287 nm and 1355-1360 nm, usable for 25GS PON services, at connection 910. The reflect port 909 of filter 908 may then be routed to an XGS-PON filter 912 for filtering to a connection 914 having wavelength ranges of 1260 to 1280 nm as well as 1575 to 1581 nm. The reflect port 913 signal of the XGS-PON filter 912 is then provided to a point-to-point filter 916, which passes wavelengths at connection 918 in a range of 1529.55 to 1560.61 nm, corresponding to the overall wavelength range of Groups A through D, described above (analogous to filter 812).

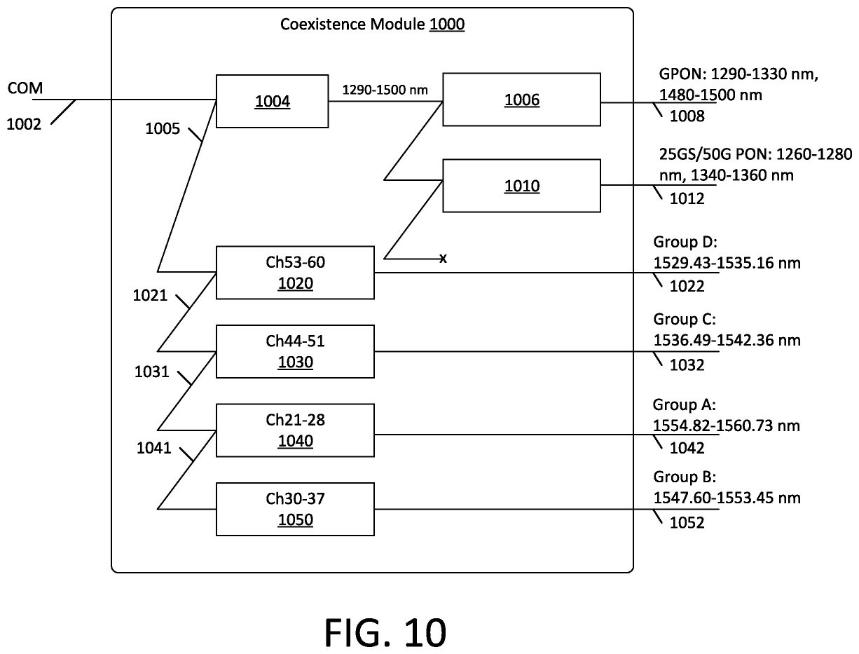

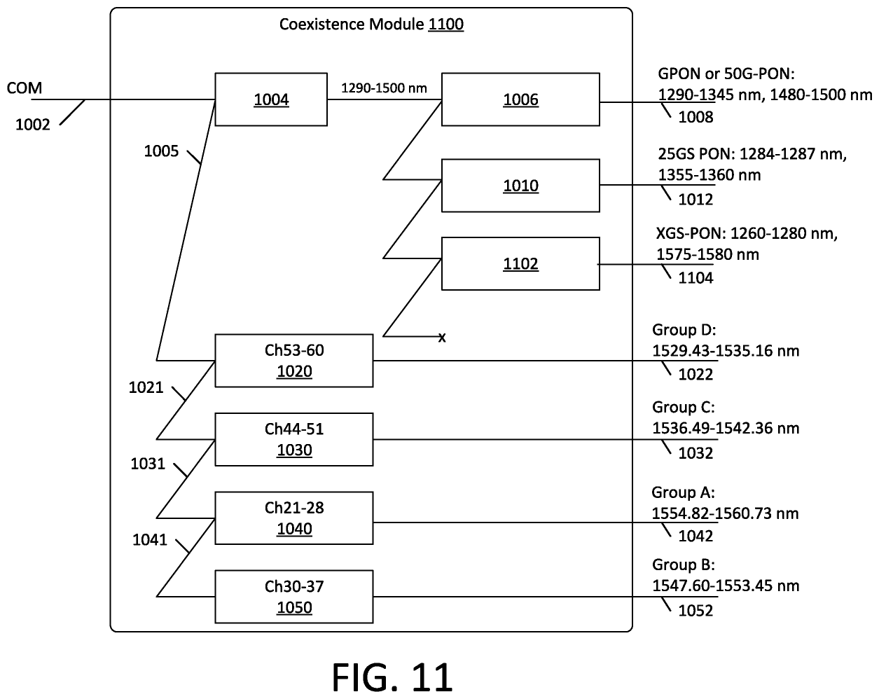

Referring to FIGS. 10-11, additional coexistence modules are described which may be used for delivery of separate GPON, 25 Gb or 50 Gb PON, XGS-PON, and point-to-point (PTP) services. The coexistence modules of FIGS. 10-11 are generally similar in structure to those described above in conjunction with FIGS. 2-3, but include an additional filter providing 25 Gb or 50 Gb PON services, in a wavelength range of 1260 to 1280 nm and 1340 to 1360 nm.

In the specific example shown, FIG. 10 illustrates a coexistence module 1000 that provides GPON, 25 Gb or 50 Gb PON, and point-to-point services. In this example, a common fiber 1002 can be connected to, for example, a common fiber 40. An initial PON filter 1004 may pass wavelengths in a range of 1290 to 1500 nm. That wavelength range may then be supplied to a GPON filter 1006 which passes GPON signals in a range of 1290 to 1330 nm and 1480 to 1500 nm to a GPON output 1008. The wavelength range may also be supplied to a 25 Gb or 50 Gb PON filter 1010, which passes wavelengths in a range of 1260 to 1280 nm and 1342 1360 nm to a connection 1012. Accordingly, in this example, the 50 Gb PON service can be delivered on the same connection 1012 as the 25 Gb PON service.

As above with respect to FIG. 2, the reflect port 1005 of the PON filter 1004 may be optically connected to a cascaded set of filters 1020, 1030, 1040, 1050, which are arranged in a cascading arrangement (where unused wavelengths are passed along via reflect ports 1021, 1031, 1041 of the respective filters) and lead to connections 1022, 1033, 1042, 1052, respectively. Each of these connections provides a service having a wavelength range analogous to that described above in conjunction with FIG. 2. As above, the relatively narrowly-spaced channels of optical signals may be combined on a common fiber 40, and distributed at remote locations with relatively low insertion loss, to ensure high quality service without requiring laying of additional fibers between a central office and remote locations.

In the coexistence module 1100 seen in FIG. 11, an additional XGS-PON filter 1102 is provided, cascaded with filters 1006, 1010. In this instance, the 25 Gb PON filter 1010 passes wavelengths of 1284 to 1287 nm and 1355 1360 nm. The XGS-PON filter 1102 passes wavelengths in a range of 1260 to 1281 nm and 1575 to 1580 nm to output 1104. Accordingly, a narrow wavelength band separates portions of the 25 Gb PON services and the XGS-PON services with low insertion loss and high isolation. The coexistence module 1100 of FIG. 11 is otherwise analogous to that described above in conjunction with FIGS. 2 and 10.

Notably, in the coexistence module 1100 of FIG. 11, the 50 Gb PON service will be delivered at the connection 1008 from filter 1006, rather than coexisting with the 25 Gb service on the connection 1012. Accordingly, as users elect to upgrade to improved services, the same connections may be utilized by subscribes while switching from a lower data rate service to a higher data rate service.

Referring to FIGS. 1-11 generally, in each of the above coexistence module configurations, a single fiber, common set of wavelength may be separated onto multiple service connections with low insertion loss. By maintaining a high degree of isolation between the different connections, this low insertion loss may be maintained despite closely spaced communication channels, even between the point-to-point services and the various PON services that may be supplied by such a coexistence module. Additionally, a very high return loss may be maintained by using multiple, cascaded filters, which assists with isolation among the various services. For example, in some instances, using a cascaded set of filters, an increased channel isolation of, for example over 45 dB, and in some instances over 60 dB, may be achieved, between at least the passive optical network services and point-to-point services that are delivered on the common optical fiber to the outside plant location.

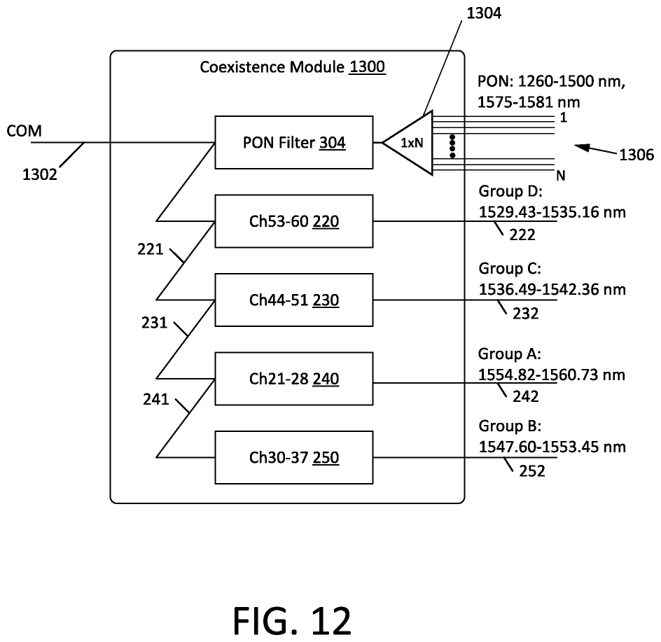

FIG. 12 is a schematic view of another example coexistence module 1300 usable within a passive optical network, according to an embodiment of the present disclosure. Generally, the module 1300 corresponds to the module 200, except that it also includes a splitter 1304. The module 1300 could be used in the specific arrangement seen in FIG. 1, wherein the splitter function is moved from a separate FDH 30 into coexistence module 1300, within outside plant location 14.

Improved efficiency may be achieved with module 1300 with an internal splitter 1304 where splitter functions are desired. Splitter outputs 1306 are connected within the optical network to subscribers 50, 52. With an internal splitter 1304, the connections between elements of the coexistence module 1300, in this case a PON filter 304, can be made, and also tested, in a factory setting, instead of in an outside field environment. Further, the connections between the splitter 1304 and the PON filter 304 are protected within the enclosed structure of the coexistence module 1300.

All of the noted modules of FIGS. 3-11, modules 300, 400, 500, 600, 700, 800, 900, 1000, 1100 can include a splitter 1304 as desired.

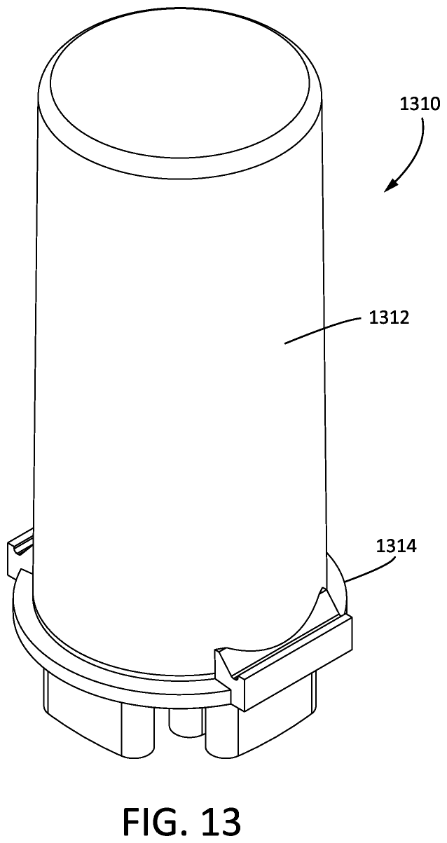

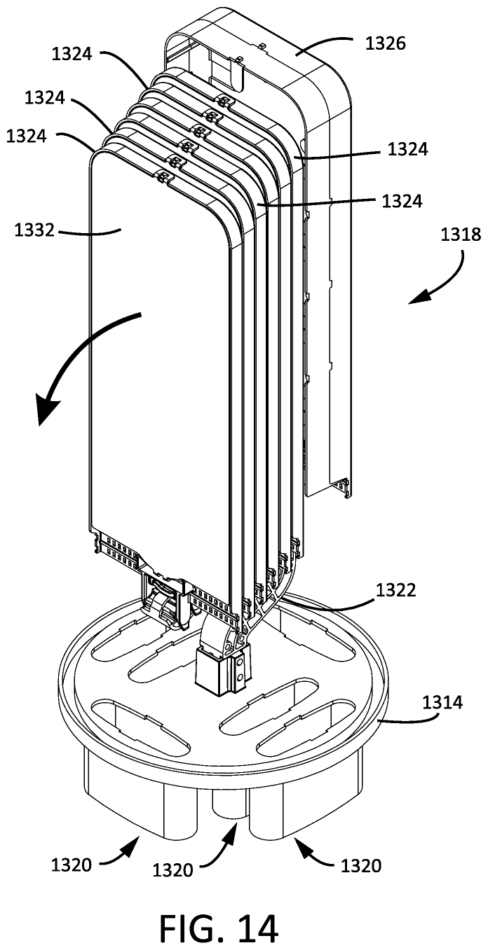

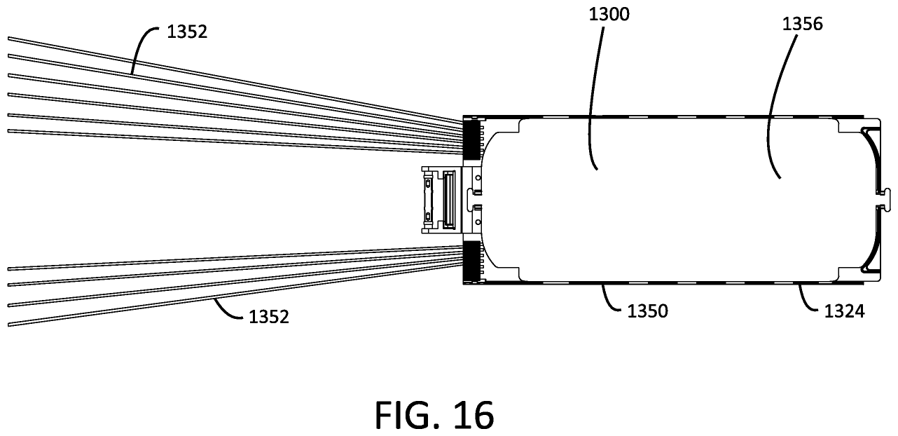

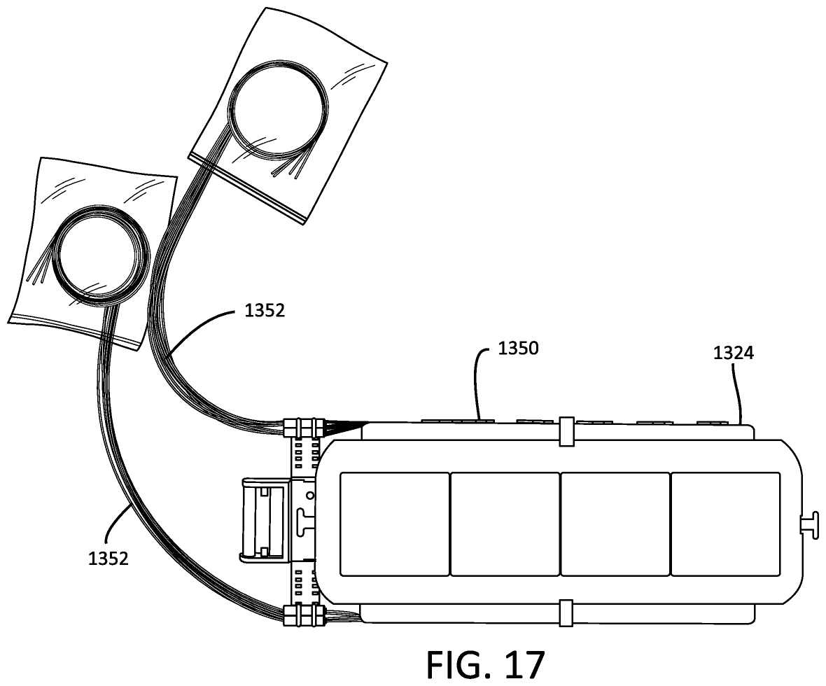

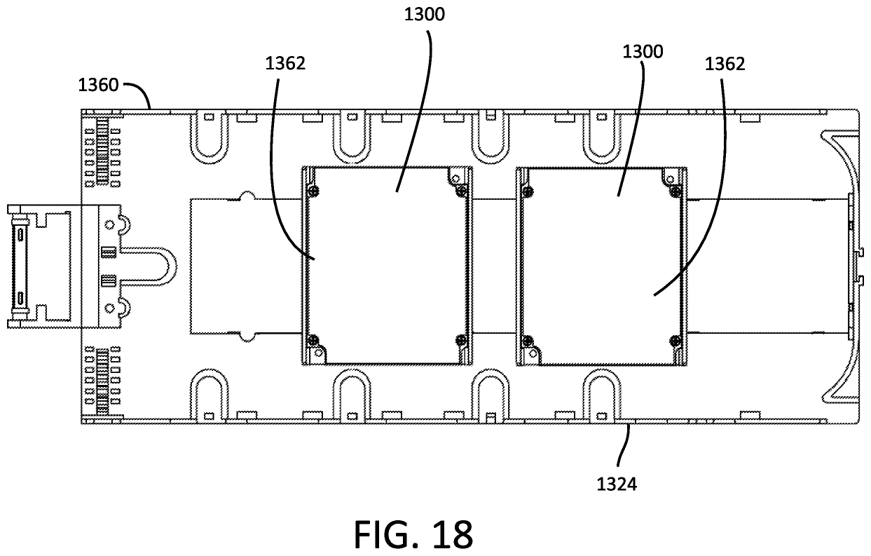

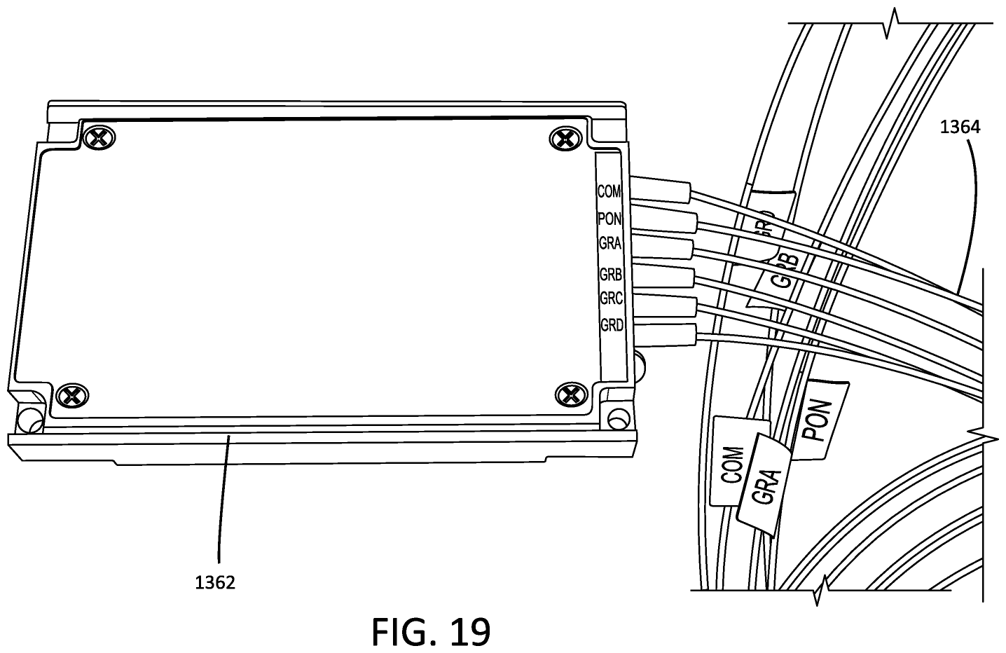

Referring now to FIGS. 13-19, an application of coexistence module 1300 is shown in one implementation. An enclosure 1310 is shown in FIG. 13 including a base 1314 and a dome cover 1312. Referring now to FIG. 14, dome cover 1312 is removed exposing an interior area of enclosure 1310. FIG. 14 also shows base 1314 including a plurality of cable ports 1320. Internal to the enclosure is an organizer structure 1318 including a plurality of trays 1324 hingedly mounted to a support 1322 for selective access to a desired tray 1324. See the arrow depicting movement of the hinged trays 1324. A fiber storage basket 1326, such as for loop cables or slack, may also be provided. Dome cover 1312 is sealed to base 1314. Cable ports 1320 are sealed around incoming and outgoing cables. Trays 1324 can hold fibers, including slack storage, and various devices like splices, power splitters, WDMs, or filters. Preferably, all of the trays 1324 have covers that are removable, or in some cases described below, not removable.

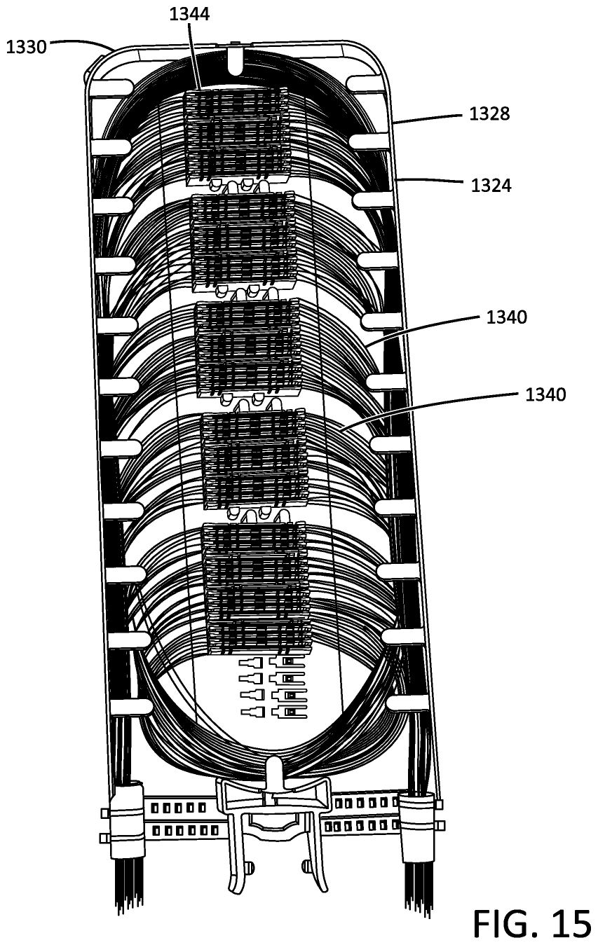

Referring now to FIGS. 14 and 15, one of the trays 1324 can be in the form of a splice tray 1328. Splice tray 1328 includes a base 1330 and a removable cover 1332. In an internal area of base 1330, a plurality of fibers 1340 are routed to and from fiber optic splices 1344. Fiber over length (slack) is stored on tray 1328 within the protected interior of the tray 1328.

Referring now to FIGS. 14, 16, and 17, one of the trays 1324 can be in the form of a tray 1350 which includes a sealed coexistence module 1300, with cable inputs and outputs 1352. The cable inputs and outputs 1352 can be spliced to cables within the enclosure 1310 on splice trays 1324. Sealed module 1300 includes an enclosure structure 1356 comprising a cover and a tray body, wherein a technician has limited access to the interior components of tray 1350. Only the cable inputs and outputs 1352 to and from the tray body are accessible to the technician. Tray 1350 can be installed at the factory to support 1322 during initial assembly. Alternatively, tray 1350 can be added to support 1322 after initial assembly and after enclosure 1310 is installed in the field.

Referring now to FIGS. 14, 18, and 19, one of the trays 1324 can be in the form of a tray 1360 which includes one or more sealed modules 1300 in the form of a cassette 1362, with cable inputs and outputs 1364. The cassettes are sealed in that a technician cannot access the interior. The cassettes can be mounted to a tray base 1330. In a similar manner to tray 1350, tray 1360 limits technician access to an interior of the sealed modules 1300 in the form of the cassettes 1362 mounted to a base 1330 of tray 1360. Also, in a similar manner as trays 1350 only the cable inputs and outputs 1364 are accessible to the technician. Tray 1360 can be installed at the factory to support 1322 during initial assembly. Alternatively, tray 1360 can be added to support 1322 after initial assembly and after enclosure 1310 is installed in the field. Cassettes 1362 themselves can be mounted as well to the tray 1360 in the factory or in the field.

Trays 1350 and cassettes 1362 useable on trays 1360 provide a common housing structure which houses both the filter arrangement and the splitter. In some applications, this common housing arrangement is preferred over the arrangement shown in FIG. 1 where the filter arrangement is separate and in a different housing from the splitter. The common housing construction of trays 1350 and cassettes 1362 can lead to improved manufacturing efficiencies and cable protection when assembling enclosure 1310 for shipment and while in use. The common housing of trays 1350 and cassettes 1362 can lead to improved cable protection and upgrades to enclosure 1310 when a single unit is added with both the filtering and splitting functions combined in one housing construction.

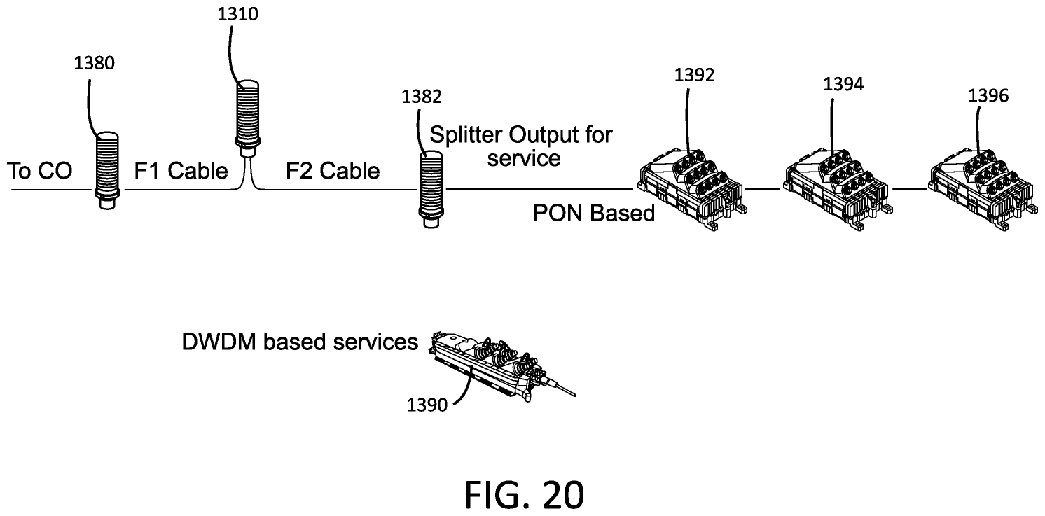

Referring now to FIGS. 1 and 20, both figures illustrate schematically examples of passive optical networks in which the various coexistence modules may be used. The module 1300 of FIGS. 12-19, as well as the modules of FIGS. 1-11 can be used in the networks shown in FIGS. 1 and 20. FIG. 20 shows the use of various enclosures 1310, 1380, 1382. Enclosure 1310 has been described above and shown in FIGS. 13 and 14.

Enclosure 1310 can be factory sealed with the coexistence components of the various modules noted above, and the splitter also noted above. The F1 and the F2 cables can be supplied (e.g., 50-200 feet of cable) and the ends spliced within enclosure 1310 in the factory. Those cables can then be spliced into the network at enclosures 1380 and 1382 for connecting to the central office and to the various downstream elements 50, 52, 55, 56, 57, 58, respectively as shown in FIGS. 1 and 20. FIG. 20 also illustrates some of the downstream connectivity components useful for making such connections, in one example including terminals 1390, 1392, 1394, 1396.

Enclosure 1310 can also be installed in the field with or without the coexistence modules described above. These modules can be added after the enclosure 1310 has been installed in the field. In the case of the module 1300, this unit can be added to enclosure 1310 in the field and then spliced with the use of one or more splice trays 1324 to the F1 and F2 cables.

While particular uses of the technology have been illustrated and discussed above, the disclosed technology can be used with a variety of data structures and processes in accordance with many examples of the technology. The above discussion is not meant to suggest that the disclosed technology is only suitable for implementation with the structures shown and described above.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

1. A passive optical module comprising:
a common optical connection optically coupled to a single optical fiber, the single optical fiber carrying a plurality of optical services thereon, the plurality of optical services including a passive optical network service and a point-to-point optical service having a plurality of groups of optical channels;
a passive optical network filter arrangement optically connected to the common optical connection and providing a passive optical network service connection, the passive optical network filter arrangement having a reflect port;
a plurality of point-to-point optical filters optically connected in a cascaded arrangement, wherein:
each point-to-point optical filter receives optical signals from a reflect port of one other filter within the passive optical module and includes a point to-point optical service connection for one of the plurality of groups of channels, the one other filter being one of (1) the passive optical network filter or (2) another of the point-to-point optical filters.

2. The passive optical module of claim 1, wherein the passive optical network service connection comprises a GPON service connection, on which services in a wavelength range of 1290 to 1500 nm are delivered.

3. The passive optical module of claim 2, wherein the plurality of point-to-point optical filters include:
a first optical filter optically connected to the reflect port of the passive optical network filter, the first optical filter having a first point-to-point service connection;
a second optical filter optically connected to a reflect port of the first optical filter, the second optical filter having a second point-to-point service connection;
a third optical filter optically connected to the reflect port of the passive optical network filter, the first optical filter having a third point-to-point service connection;
a fourth optical filter optically connected to the reflect port of the passive optical network filter, the first optical filter having a fourth point-to-point service connection;

4. The passive optical module of claim 3, wherein:
the first point-to-point service connection provides a service utilizing wavelengths in a range of 1529.43 to 1535.16 nm;
the second point-to-point service connection provides a service utilizing wavelengths in a range of 1536.49 to 1542.36 nm;
the third point-to-point service connection provides a service utilizing wavelengths in a range of 1554.82 to 1560.73 nm; and
the fourth point-to-point service connection provides a service utilizing wavelengths in a range of 1547.60 to 1553.45 nm.

5. The passive optical module of claim 2, further comprising an XGS-PON service connection, on which services in a wavelength range of 1260 to 1280 nm and 1575 to 1581 nm are delivered.

6. The passive optical module of claim 5, wherein the passive optical network filter arrangement includes a GPON filter and an XGS-PON filter, wherein the GPON filter includes the GPON service connection and the XGS-PON filter includes the XGS-PON service connection.

7. The passive optical module of claim 6, wherein the passive optical network filter arrangement further includes a further passive optical network filter providing a third passive optical network service different from services delivered at the GPON service connection and the XGS-PON service connection.

8. The passive optical module of claim 6, wherein the reflect port is included on the XGS-PON filter.

9. The passive optical module of claim 1, wherein the passive optical network filter arrangement comprises one or more wavelength division multiplexers selected from between point-to-point wavelength division multiplexers and passive optical network (PON) wavelength division multiplexers.

10. The passive optical module of claim 1, wherein the plurality of point-to-point optical filters comprises a plurality of 8-skip-1 (8S1) filters.

11. The passive optical module of claim 1, wherein the passive optical module has a total channel isolation for each of the plurality of point-to-point service connections of at least 60 dB.

12. The passive optical module of claim 1, wherein each of the passive optical network filter arrangement and the plurality of point-to-point optical filters has a channel isolation of at least 15 dB.

13. The passive optical module of claim 1, wherein the passive optical module comprises a fiber optic splice enclosure.

14. The passive optical module of claim 1, further comprising a splitter with a splitter input optically connected to the passive optical network service connection, the splitter outputs optically connectable to a plurality of subscriber locations.

15. The passive optical module of claim 14, wherein the splitter, the passive optical network service connection of the passive optical module, and the passive optical network filter arrangement having a reflect port, are contained in a common housing in the form of a cassette or tray.

16. A method of delivering multiple optical services from a central office, the method comprising:
delivering from a central office to an outside plant location, one or more passive optical network services on a common optical fiber with a plurality of point-to-point services, the passive optical network services and the point-to-point services being delivered using different ranges of wavelengths;
at the outside plant location, receiving the common optical fiber at a passive optical module;
delivering a passive optical network service at a passive optical network service connection of the passive optical module, the passive optical network service connection being optically connected to the passive optical network service connection via a passive optical network filter arrangement having a reflect port;
delivering a plurality of point-to-point optical services from the passive optical module, wherein each of the plurality of point-to-point optical services is provided at the output of a point-to-point optical filter of a plurality of point-to-point optical filters optically connected in a cascaded arrangement.

17. The method of claim 16, wherein each of the passive optical network filter arrangement and the plurality of point-to-point optical filters has a channel isolation of at least 15 dB.

18. The method of claim 16, wherein there is at least 45 dB of channel isolation between the passive optical network service and the plurality of point-to-point optical services.

19. The method of claim 16, further comprising optically connecting a splitter to the passive optical network service connection, the splitter optically connected to a plurality of subscriber locations.

20. The method of claim 19, wherein the plurality of subscriber locations each receive one or more passive optical network services.

21. The method of claim 20, wherein the plurality of subscriber locations includes a first subscriber location receiving a GPON optical service and a second subscriber location receiving an XGS-PON optical service.

22. The method of claim 16, wherein each of the point-to-point optical services includes a plurality of optical channels.

23. The method of claim 19, wherein the splitter, the passive optical network service connection of the passive optical module, and the passive optical network filter arrangement having a reflect port, are contained in a common housing in the form of a cassette or tray.
